(19) United States
(12) Patent Application Publication
(10) Pub. No.: US 2026/0253766 A1
(43) Pub. Date: Aug. 27, 2026

(54) ELECTRONIC COMPONENT

(71) Applicant: Panasonic Intellectual Property Management Co., Ltd., Osaka (JP)

(72) Inventors: Takashi OHBAYASHI, Osaka (JP); Yoshitaka NAKAMURA, Osaka (JP); Hirokatsu ITO, Fukui (JP); Kyousuke ISONO, Osaka (JP)

(21) Appl. No.: 18/714,482

(22) PCT Filed: Nov. 29, 2022
(86) PCT No.: PCT/JP2022/044051

§ 371 Date: May 29, 2024

(30) Foreign Application Priority Data
Dec. 13, 2021 (JP) 2021-201917

(51) Int. Cl. H01C 1/142; H01C 1/032; H01C 7/00

(52) U.S. Cl. CPC H01C 1/142; H01C 1/032; H01C 7/003

(57) ABSTRACT

An electronic component includes: a substrate; an element part on the substrate; extraction electrodes connected to the element part; an insulating protective layer; intermediate electrodes; and external electrodes each covering a corresponding one of the intermediate electrodes. The insulating protective layer covers the element part and part of each of the extraction electrodes. Each of the intermediate electrodes covers part of the insulating protective layer and a surface of a portion of a corresponding one of the extraction electrodes, the portion not being covered with the insulating protective layer. Each of the intermediate electrodes includes conductive particles and a resin component. The conductive particles include fiber-like conductive particles and flake-like conductive particles.

### TECHNICAL FIELD

The present disclosure relates to electronic components. More specifically, the present disclosure relates to an electronic component including a substrate having an element part.

### BACKGROUND ART

Patent Literature 1 describes a chip resistor. The chip resistor includes: a substrate having a top surface; a resistor layer disposed on the top surface of the substrate; a pair of first upper electrode layers disposed on the top surface of the substrate and being electrically connected to the resistor layer at both sides of the resistor layer; and a pair of second upper electrode layers disposed on the pair of first upper electrode layers and including between 75% by weight and 85% by weight (inclusive) of silver particles with an average particle diameter ranging from 0.3 μm to 2 μm, between 1% by weight and 10% by weight (inclusive) of carbon, and a resin.

### CITATION LIST

### Patent Literature

Patent Literature 1: WO 2012/114673 A1

### SUMMARY OF INVENTION

Chip resistors, such as those in Patent Literature 1, require further suppression of: the occurrence of disconnection caused by a sulfidizing gas; and production of silver sulfide.

It is an object of the present disclosure to provide an electronic component in which disconnection caused by a sulfidizing gas is suppressed from occurring and a sulfide is also suppressed from being produced.

An electronic component according to an aspect of the present disclosure includes a substrate, an element part on the substrate, extraction electrodes connected to the element part, an insulating protective layer, intermediate electrodes, and external electrodes each covering a corresponding one of the intermediate electrodes. The insulating protective layer covers the element part and part of each of the extraction electrodes. Each of the intermediate electrodes covers part of the insulating protective layer and a surface of a portion of a corresponding one of the extraction electrodes, the portion not being covered with the insulating protective layer. Each of the intermediate electrodes includes conductive particles and a resin component. The conductive particles include fiber-like conductive particles and flake-like conductive particles.

### BRIEF DESCRIPTION OF DRAWINGS

FIG. 1 is a sectional view of an electronic component (chip resistor) according to the present embodiment;

FIGS. 2A to 2C are illustrative views of respective manufacturing process steps of the electronic component (chip resistor) according to the present embodiment; and

FIGS. 3A to 3H are illustrative views of respective manufacturing process steps of the electronic component (chip resistor) according to the present embodiment.

### DESCRIPTION OF EMBODIMENTS

### Embodiment

### (1) Overview

An electronic component 10 according to the present embodiment has a similar configuration to the chip resistor described in Patent Literature 1. That is, the electronic component 10 includes: a substrate 1; an element part 2 on the substrate 1; extraction electrodes 3 connected to the element part 2; an insulating protective layer 13; intermediate electrodes 9; and external electrodes 14 each covering a corresponding one of the intermediate electrodes 9. The insulating protective layer 13 covers the element part 2 and part of each of the extraction electrodes 3. Each of the intermediate electrodes 9 covers part of the insulating protective layer 13 and a surface of a portion of a corresponding one of the extraction electrodes 3, the portion not being covered with the insulating protective layer 13. Further, each of the intermediate electrodes 9 includes conductive particles and a resin component, and the conductive particles include fiber-like conductive particles and flake-like conductive particles.

In such a configuration, the extraction electrodes 3 are entirely covered with the insulating protective layer 13 and the intermediate electrodes 9, which reduces, even in a sulfidizing gas atmosphere, the chances of a sulfuric acid gas affecting the extraction electrodes 3. This can suppress a conductor (metal) included in the extraction electrodes 3 from turning into a sulfide, thereby suppressing disconnection of the extraction electrodes 3 from occurring. Note that the disconnection of the extraction electrodes 3 includes both physical disconnection of the extraction electrodes 3 due to a grown sulfide and electrical disconnection of the extraction electrodes 3 due to an electric resistance increased by a sulfide.

Further, each of the intermediate electrodes 9 includes the resin component, the fiber-like conductive particles, and the flake-like conductive particles and thus has good adhesion to, and reduced chances of being peeled off from, a corresponding one of the extraction electrodes 3 and also has a low resistance value, and production of the sulfide (crystal growth) from the intermediate electrodes 9 can also be suppressed, thereby reducing exterior defects.

### (2) Details

### (2.1) Electronic Component

The electronic component 10 according to the present embodiment is a chip resistor. The chip resistor may be, for example, a surface-mounted (SMT) chip resistor to be mounted on a surface (i.e., a mounting surface) of a printed wiring board using a surface mounter. Furthermore, the chip resistor may be, for example, a thick film chip resistor.

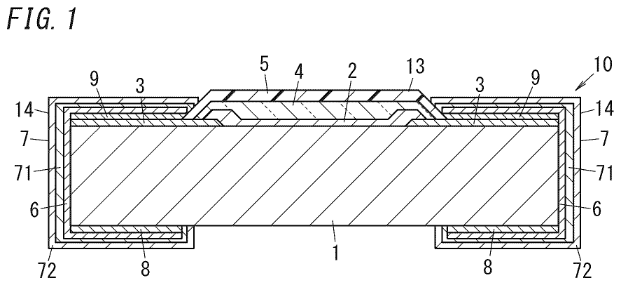

As shown in FIG. 1, the electronic component 10 includes, for example, the substrate 1, the element part 2, the extraction electrodes 3, the insulating protective layer 13, the intermediate electrodes 9, and the external electrodes 14.

The substrate 1 is electrically insulating and may be, for example, an alumina substrate containing 96% to 99% Al₂O₃ (alumina). When viewed in plan (i.e., when viewed from over the paper of FIG. 1), the substrate 1 may have, for example, a rectangular shape such as an oblong shape.

The element part 2 is a resistor body, is electrically resistive, is a thick film, and is disposed on one surface (upper surface in FIG. 1) of the substrate 1. The element part 2 may be made of RuO₂, AgPd, or CuNi, for example. The element part 2 is located in a substantially central area of the substrate 1 in plan view and has a rectangular shape such as an oblong shape in plan view.

The extraction electrodes 3 are upper surface electrodes disposed as a pair on the upper surface of the substrate 1. The extraction electrodes 3 are electrically connected to the element part 2 at both longitudinal ends of the element part 2 (i.e., at both ends in the rightward/leftward direction shown in FIG. 1). Specifically, one end portion of each extraction electrode 3 is located under the element part 2, and the other end portion of each extraction electrode 3 is located at either the right end or left end of the substrate 1.

The extraction electrodes 3 include silver of metal. Moreover, the extraction electrodes 3 may include metal such as copper, gold, nickel, tin, etc. The extraction electrodes 3 are made of, for example, a cured material of a conductive paste. The conductive paste contains, for example, a resin component or a glass component, and conductor particles. The conductor particles may be formed of particles including the above-mentioned metal. The extraction electrodes 3 may be formed, for example, as Ag-based cermet thick-film electrodes.

The insulating protective layer 13 is a layer for reducing the chances of a gas, such as a sulfidizing gas, and moisture (humidity) coming into contact with the element part 2, thereby protecting the element part 2. The insulating protective layer 13 covers the entirety of the element part 2. Moreover, the insulating protective layer 13 covers part of each extraction electrode 3. Here, the part of each extraction electrode 3 is the end of each extraction electrode 3 which is connected to the element part 2 and a peripheral part of the end. Thus, the insulating protective layer 13 protects connection parts where the element part 2 is connected to the extraction electrodes 3, thereby reducing the chances of the gas and the moisture affecting, and the chances of corrosion at, the connection parts where the element part 2 is connected to the extraction electrodes 3.

The insulating protective layer 13 is an electrically insulating layer and includes a glass coating (precoat glass) 4 and a resin portion 5. The glass coating 4 is disposed on a surface of the element part 2 and covers the entirety of the element part 2. The glass coating 4 partially covers the extraction electrodes 3 at both longitudinal ends (i.e., at both ends in the rightward/leftward direction shown in FIG. 1). That is, when viewed in the thickness direction defined for the element part 2 (i.e., in the thickness direction defined for the substrate 1), the glass coating 4 covers the boundary between the element part 2 and the pair of extraction electrodes 3 and continuously covers a range from the element part 2 through the ends of the pair of extraction electrodes 3 and the peripheral parts of the end. The resin portion 5 is disposed on a surface of the glass coating 4 to entirely cover the glass coating 4. Thus, the resin portion 5 entirely covers the element part 2 via the glass coating 4.

The glass coating 4 is made of an inorganic material. Examples of the inorganic material include glass materials such as crystal glass or quartz glass and Al₂O₃ (alumina). Alternatively, the glass coating 4 may be made of any metal oxide other than alumina or a metal nitride.

The resin portion 5 is a layer for protecting the element part 2 and the glass coating 4. The resin portion 5 is made of a cured material of a coating agent including an epoxy resin. The resin portion 5 entirely covers the surface of the glass coating 4 and partially covers the pair of extraction electrodes 3. That is, when viewed in the thickness direction defined for the element part 2, the resin portion 5 covers the boundary between the glass coating 4 and the pair of extraction electrodes 3 and continuously covers a range from the glass coating 4 through at least respective parts of the pair of extraction electrodes 3. Therefore, the resin portion 5 covers the element part 2. The resin portion 5 may have a rectangular shape such as an oblong shape when viewed in plan. Respective parts, located between both longitudinal end portions of the glass coating 4 (i.e., at both ends in the rightward/leftward direction shown in FIG. 1) and metal plating layers 7, of the pair of extraction electrodes 3 are directly covered with the resin portion 5.

The resin portion 5 may contain silica particles and silicone rubber particles other than the resin. This allows the resin portion 5 to relax the stress caused to the resin portion 5 due to heat, for example, compared to a situation where the resin portion 5 is formed out of the resin alone. This makes it easier for thermal expansion and shrinkage of the resin portion 5 to follow the thermal expansion and shrinkage of the glass coating 4. This reduces the chances of causing peeling between the resin portion 5 and the glass coating 4.

The intermediate electrodes 9 serve as electrodes. Moreover, the intermediate electrodes 9 serve also as layers for protecting the extraction electrodes 3. That is, the intermediate electrodes 9 suppress the extraction electrodes 3 from coming into contact with the gas and the moisture, thereby reducing the chances of corrosion, and additionally, reducing a sulfide such as silver sulfide from being produced on the extraction electrodes 3. This suppresses the extraction electrodes 3 from being disconnected, and additionally, suppresses the exterior appearance from being degraded due to production of the sulfide.

The intermediate electrodes 9 cover respective parts of the insulating protective layer 13. Here, the parts of the insulating protective layer 13 are end portions of the insulating protective layer 13, and end surfaces of the intermediate electrodes 9 are in contact with a surface of the resin portion 5, thereby covering respective end portions of the resin portion 5. Thus, a boundary part between the insulating protective layer 13 and each of the extraction electrodes 3 is covered with a corresponding one of the intermediate electrodes 9.

Each intermediate electrode 9 covers part of a corresponding one of the extraction electrodes 3. Here, the part of a corresponding one of the extraction electrodes 3 is a portion not covered with the insulating protective layer 13. Each intermediate electrode 9 is disposed on the surface of the portion, which is not covered with the insulating protective layer 13, of the corresponding one of the extraction electrodes 3. Each intermediate electrode 9 covers the surface of the corresponding one of the extraction electrodes 3 in this manner, thereby reducing gas and moisture coming into contact with the corresponding one of the extraction electrodes 3.

The electronic component 10 further includes a pair of back surface electrodes 8. The pair of back surface electrodes 8 are disposed on a lower surface (a surface on which neither the element part 2 nor the extraction electrodes 3 are disposed) of the substrate 1. Each of the pair of back surface electrodes 8 may be formed, for example, as an Ag-based cermet thick-film electrode. The pair of back surface electrodes 8 are located at both longitudinal ends of a back surface (i.e., a lower surface shown in FIG. 1) of the substrate 1 (i.e., at both ends in the rightward/leftward direction shown in FIG. 1). The pair of back surface electrodes 8 correspond one to one to the pair of extraction electrodes 3. Optionally, the pair of back surface electrodes 8 may be omitted.

The external electrodes 14 are portions used as terminals for electrical connection when the electronic component 10 is to be mounted on an apparatus. The external electrodes 14 include a pair of electrode layers (end face electrodes) 6 and a pair of metal plating layers 7. Each of the pair of electrode layers 6 is formed of, for example, a metal layer including metal, such as Ag. The pair of electrode layers 6 are located at both longitudinal ends of the substrate 1 (i.e., at both ends in the rightward/leftward direction shown in FIG. 1). Each of the pair of electrode layers 6 is electrically connected to a corresponding one of the pair of extraction electrodes 3 and a corresponding one of the pair of back surface electrodes 8. Each of the pair of electrode layers 6 is in contact with surfaces of opposite ends of the corresponding one of the extraction electrodes 3 and the corresponding one of the back surface electrodes 8 from the element part 2. Thus, each of the pair of electrode layers 6 covers a corresponding one of the intermediate electrodes 9 and the corresponding one of the back surface electrodes 8.

Each electrode layer 6 is preferably formed from a conductor including a resin component, carbon particles, and silver powder, for example. In this case, the resin component is, for example, a phenoxy resin or an epoxy resin. The carbon particles are blended with the purpose of supplementing the electrically conductive property of the electrode layers 6. Moreover, when the electrode layers 6 are made of a cured material of a conductive paste, the carbon particles are blended as a colorant so that the application of the conductive paste is perceivable. As the silver powder, a whisker-like particles of an inorganic filler which have surfaces covered with a conductive film made of silver and a flake-like silver powder may be used. The whisker-like particles of the inorganic filler enables the flexure strength of the electrode layer 6 to be improved. The flake-like silver powder enables the adhesion between each electrode layer 6 and each metal plating layer 7 to be improved. Moreover, each electrode layer 6 may be a conductor formed by sputtering of metal such as a nickel-chrome alloy.

Each of the pair of metal plating layers 7 includes a first plating layer 71 and a second plating layer 72. Each of the pair of metal plating layers 7 is connected to part of a corresponding one extraction electrode 3 of the pair of extraction electrodes 3 and is in contact with the surface of the resin portion 5 of the insulating protective layer 13. Moreover, each of the pair of metal plating layers 7 covers a corresponding one electrode layer 6 of the pair of electrode layers 6. The first plating layer 71 may be made by, for example, Ni plating. The second plating layer 72 may be made by, for example, Sn plating.

The external electrodes 14 cover respective parts of the insulating protective layer 13. Here, the parts of the insulating protective layer 13 are end portions of the insulating protective layer 13, and end portions, facing the element part 2, of the extraction electrodes 3 are covered with the end portions of the insulating protective layer 13. Thus, covering the end portions of the insulating protective layer 13 with the external electrodes 14 enables the boundary between the insulating protective layer 13 and the extraction electrodes 3 to be covered with the external electrodes 14, thereby suppressing the gas and the moisture from entering the extraction electrodes 3.

### (2.2) Intermediate Electrode

Each of the intermediate electrodes 9 of the electronic component 10 according to the present embodiment includes the conductive particles and the resin component. The conductive particles include the fiber-like conductive particle and the flake-like conductive particle.

Moreover, the content percentage of carbon particles in each of the intermediate electrodes 9 is preferably less than 1 wt % relative to the weight of a solid content in each of the intermediate electrodes 9. Note that the solid content in each of the intermediate electrodes 9 refers to the conductive particles, the resin component, and the carbon particles. The carbon particles are used as, for example, a colorant for supplementarily improving the electrically conductive property of the intermediate electrodes 9 and, when the intermediate electrodes 9 are made from a conductive paste, for improving the visibility as to whether or not the conductive paste has been applied. However, when the intermediate electrodes 9 include the carbon particles, the sedimentation of the conductive particles is suppressed, and many conductive particles are exposed on surfaces of the intermediate electrodes 9, and therefore, a sulfide such as silver sulfide (metal sulfide) is more likely to be produced. Therefore, in the present embodiment, the content percentage of the carbon particles is set to be less than 1 wt % relative to the weight of the solid content in each of the intermediate electrodes 9. This reduces, even when a sulfidizing gas affects the intermediate electrodes 9, the chances of crystal growth of a sulfide such as silver sulfide. From the viewpoints of the production of the sulfide, the fewer the carbon particles which are included in the intermediate electrodes 9, the more preferable, and therefore, the intermediate electrodes 9 include substantially no carbon particles. That is, the content percentage of the carbon particles in each of the intermediate electrode 9 is 0 wt %.

The content percentage of the conductive particles in each of the intermediate electrodes 9 is preferably greater than or equal to 46 wt % and less than or equal to 61 wt % relative to the weight of the solid content in each of the intermediate electrodes 9. When the content percentage is less than or equal to 61 wt %, few conductive particles are exposed on the surfaces. Therefore, within this range, the chances of the sulfide being produced on the intermediate electrodes 9 are low even in the sulfidizing gas atmosphere. In particular, when the content percentage is greater than or equal to 46 wt %, the chances of increasing the resistance value of the intermediate electrodes 9 are low, and the chances of degrading the electrically conductive property of the intermediate electrodes 9 are low. The content percentage of the conductive particles in each of the intermediate electrodes 9 is more preferably greater than or equal to 48 wt % and less than or equal to 60 wt %, and much more preferably greater than or equal to 50 wt % and less than or equal to 58 wt %, relative to the weight of the solid content in each of the intermediate electrodes 9.

The resin component included in the intermediate electrodes 9 is a cured material of a resin and preferably contains a polyfunctional epoxy resin and a curing agent. In this case, the polyfunctional epoxy resin is cured with the curing agent to form the resin component of the intermediate electrodes 9. The polyfunctional epoxy resin is an epoxy resin having a plurality of epoxy groups per molecule. The polyfunctional epoxy resin comes to have a higher cross-linking density by curing than a monofunctional epoxy resin. Thus, compared to a situation where a monofunctional epoxy resin is used, the resin portion of the intermediate electrodes 9 comes to have a higher glass transition point, thus improving the heat resistance of the intermediate electrodes 9.

As the polyfunctional epoxy resin, a polyfunctional epoxy resin expressed by any one of the following structural formulae (1) to (6) may be used. Specifically, the structural formula (1) expresses a DPP novolac epoxy resin. The structural formula (2) expresses a tetraphenylolethane epoxy resin. The structural formula (3) expresses a cresol novolac epoxy resin. The structural formula (4) expresses a dicyclopentadiene epoxy resin. The structural formula (5) expresses an arylene epoxy resin. The structural formula (6) expresses a naphthalene diol epoxy resin. In these structural formulae, n is an arbitrary integer.

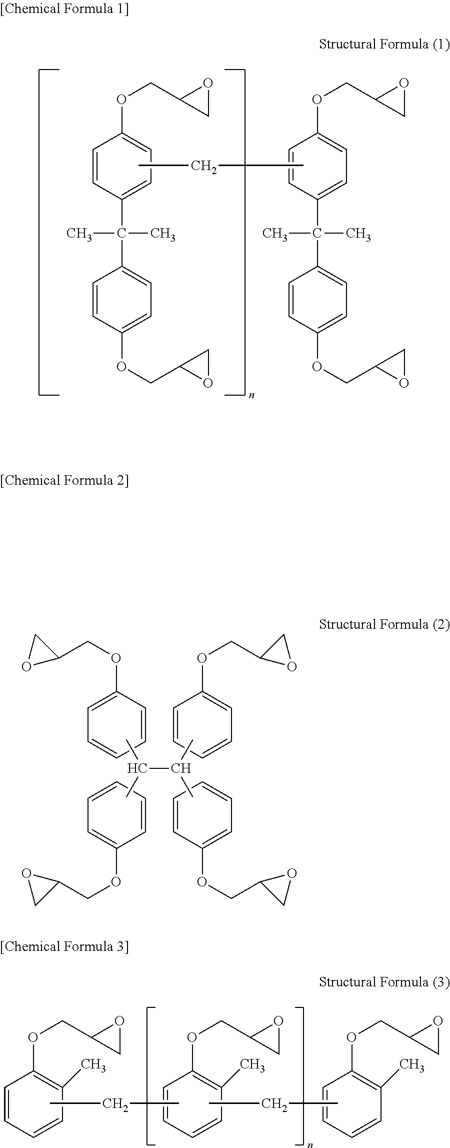

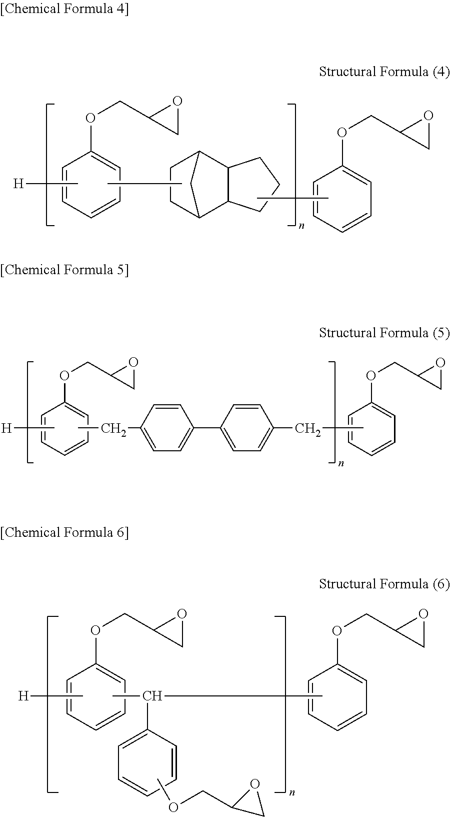

Among these polyfunctional epoxy resins, the DPP novolac epoxy resin expressed by the structural formula (1) or the tetraphenylolethane epoxy resin expressed by the structural formula (2) is preferred. These epoxy resins provide a cured material having higher flexibility than any other polyfunctional epoxy resin does. This reduces the chances of causing cracking or chipping to the intermediate electrodes 9 at the time of a heat cycle test.

The curing agent is a curing agent for a polyfunctional epoxy resin. That is to say, the polyfunctional epoxy resin is cured by the curing agent to form the resin portion. As the curing agent, at least one selected from the group consisting of imidazole-based curing agents, phenol-novolac curing agents, and dicyandiamide curing agents may be used. As the imidazole-based curing agent, an imidazole-based curing agent expressed by the following structural formula (7) may be used. As the dicyandiamide curing agent, a dicyandiamide curing agent expressed by the following structural formula (8) may be used. As the phenol novolac curing agent, a phenol novolac curing agent expressed by the following structural formula (9) may be used. In these structural formulae, n is an arbitrary integer. When the dicyandiamide curing agent is used as the curing agent, an aromatic dimethyl urea is preferably used together as a curing catalyst, thereby prompting the polyfunctional epoxy resin to cure.

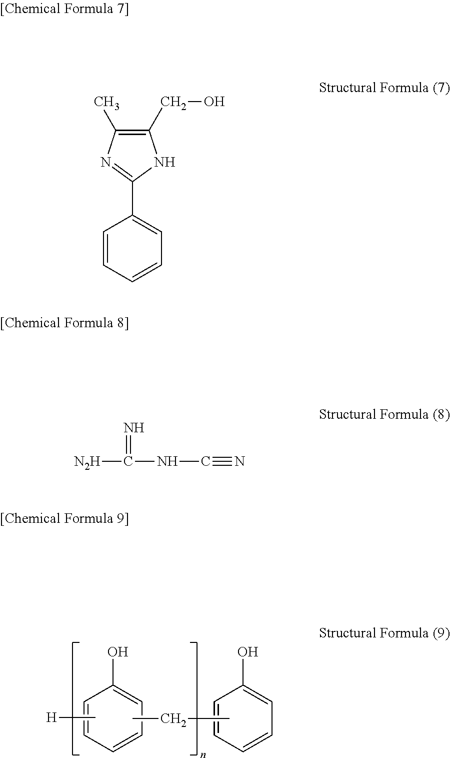

The ratio by weight between the fiber-like conductive particles and the flake-like conductive particles in each of the intermediate electrodes 9 is preferably from 5/5 to 7/3. Within this range, a sulfide can be suppressed from being produced on the intermediate electrodes 9. That is, when the proportion of the flake-like conductive particles is greater than the above-described ratio by weight of 5/5, conductive particles exposed on the surfaces increase, and therefore, silver sulfide is more likely to be produced. Moreover, when the proportion of the flake-like conductive particle is less than the above-described ratio by weight of 7/3, the resistance value is large.

The fiber-like conductive particles are preferably particles of a fiber-like inorganic substance which are covered with metal. That is, the fiber-like conductive particles are obtained by covering surfaces of fibers (e.g., whisker-like fibers) of an inorganic substance (inorganic filler) with a conductive film made of metal. Thus, the fiber-like conductive particles can be obtained while the usage amount of metal is reduced compared to a situation where the fiber-like conductive particles are made of metal alone.

The fiber-like inorganic substance includes at least one selected from the group consisting of potassium titanate, wollastonite, meerschaum, zinc oxide, titanium oxide, barium sulfate, magnesium sulfate, and silicon nitride. The metal, of which the conductive film is made, may include at least one selected from the group consisting of silver, copper, gold, nickel, and tin. As the fiber-like conductive particles, a plurality of types of fiber-like conductive particles may be used together which are different from each other in terms of: the type of the fiber-like inorganic substance; and the type of the metal, of which the conductive film is made. For example, fiber-like conductive particles may be used in which the fiber-like inorganic substance is potassium titanate and the metal, of which the conductive film is made, is silver.

The fiber-like conductive particles preferably have a mean fiber size of greater than or equal to 0.1 μm and less than or equal to 2 μm, a mean fiber length of greater than or equal to 5 μm and less than or equal to 30 μm, and an aspect ratio of greater than or equal to 5 and less than or equal to 200. Within these ranges, the fiber-like conductive particles are not broken while kneaded, and the resistance value can be reduced. The aspect ratio of the fiber-like conductive particles is expressed by a value (mean fiber length/mean fiber size) obtained by dividing the mean fiber length by the mean fiber size. The mean fiber size and the mean fiber length are each a value determined by SEM observation.

The flake-like conductive particles preferably include thin flake-like metal powder, thereby further suppressing a sulfide from being produced on the intermediate electrodes 9. As the thin flake-like metal powder, metal foil flakes having a small thickness may be used. The flake-like conductive particles include, for example, flake-like silver particles. The flake-like conductive particles may further include particles made of at least one type of metal selected from the group consisting of copper, gold, nickel, and tin.

The flake-like conductive particles preferably have a mean particle size of greater than or equal to 1 μm and less than or equal to 30 μm, and an aspect ratio between the thickness of each of the flake-shaped conductive particles and the mean particle size is preferably greater than or equal to 5 and less than or equal to 300, and when the aspect ratio is less than 5, the conductive particles (flake-like conductive particles) come to have a low bulk density, the conductive particles are not exposed on the surfaces, and the resistance value is high. Moreover, when the aspect ratio is greater than 300, the bulk density is too high, many conductive particles are exposed on the surfaces, and the silver sulfide is more likely to be produced. Within this range, a sulfide can further be suppressed from being produced on the intermediate electrodes 9. The aspect ratio between the thickness and the mean particle size is expressed by a value obtained by dividing the mean particle size by the thickness (mean particle size/thickness). The mean particle size is 50% particle size by a laser diffraction method.

### (2.3) Method for Manufacturing Electronic Component

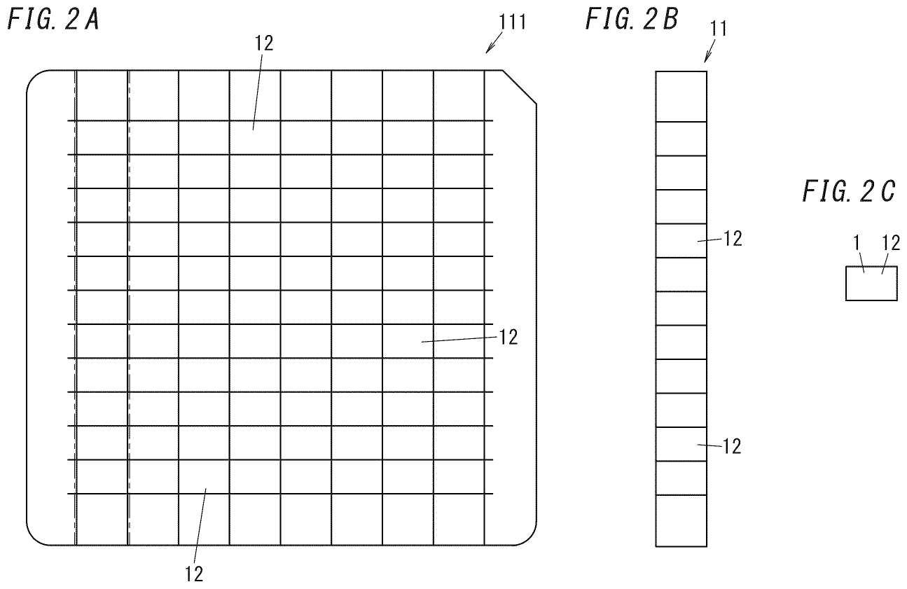

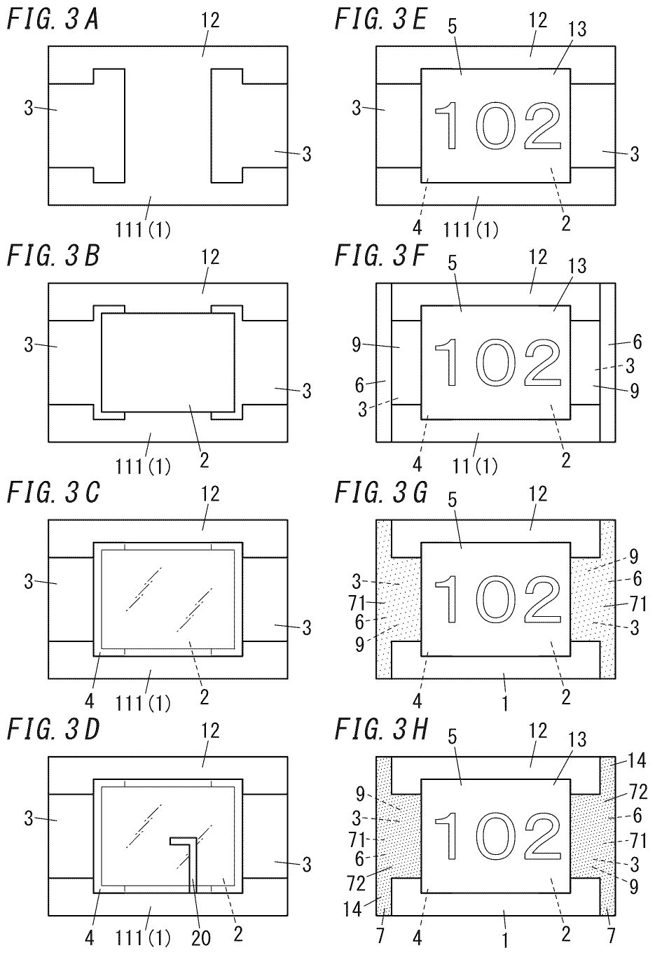

A method for manufacturing the electronic component 10 according to the present embodiment will be described based on FIGS. 2A to 2C and FIGS. 3A to 3H.

To form the electronic component 10, a sheet-shaped substrate 111 is used as shown in FIG. 2A. The sheet-shaped substrate 111 is formed in a substantially rectangular shape in plan view and is formed of the same material as the substrate 1 to the same thickness as the substrate 1. The sheet-shaped substrate 111 is formed to have larger dimensions than the substrate 1 and to allow a plurality of substrates 1 to be cut out of the sheet-shaped substrate 111. On the sheet-shaped substrate 111, a plurality of chip areas 12, each having the same dimensions as the substrate 1, have been formed. Each chip area 12 corresponds to a single substrate 1. That is to say, a single electronic component 10 is fabricated by forming the element part 2, the insulating protective layer 13, and other members on each chip area 12. The plurality of chip areas 12 are arranged side by side both vertically and laterally on the sheet-shaped substrate 111. As will be described later, after the resin portion 5 has been formed, the sheet-shaped substrate 111 will be divided into multiple strips of substrates 11. Each strip of substrates 11 includes a series of chip areas 12 which are arranged vertically as shown in FIG. 2B. Next, as will be described later, after the electrode layers 6 have been formed, each strip of the substrates 11 will be divided laterally to form a substrate 1 having a single chip area 12 as shown in FIG. 2C.

Then, back surface electrodes (not shown in any of FIGS. 2A to 2C and FIGS. 3A to 3H) are formed first on a back surface of each chip area 12 of the sheet-shaped substrate 111. Next, the extraction electrodes 3 are formed on a surface of each chip area 12 of the sheet-shaped substrate 111 (see FIG. 3A). As a material for the extraction electrodes 3 and the back surface electrodes, an Ag-based cermet conductive paste may be used, for example. The extraction electrodes 3 and the back surface electrodes may be formed by, for example, screen-printing (applying) the conductive paste onto both longitudinal end portions of the surface and the back surface of the chip area 12 and then sintering the conductive paste. Alternatively, the extraction electrodes 3 and the back surface electrodes may also be formed by forming, by sputtering, a metal film at both longitudinal end portions of the surface and the back surface of the chip area 12 and then removing unnecessary parts of the film by photolithographic and etching techniques.

After the extraction electrodes 3 have been formed, the element part 2 is formed on the surface of each chip area 12 of the sheet-shaped substrate 111 (see FIG. 3B). The element part 2 may be formed by, for example, screen-printing (applying) a resistive paste including RuO₂ onto the surface of the chip area 12 and then baking the resistive paste.

After the element part 2 has been formed, the glass coating 4 is formed to cover the surface of the element part 2 (refer to FIG. 3C). The glass coating 4 may be formed by, for example, screen-printing (applying) a glass coating agent onto each chip area 12 and then baking the glass coating agent.

After the glass coating 4 has been formed, trimming is performed (refer to FIG. 3D). The trimming is conducted to adjust the resistance value of the electronic component 10. The trimming is performed to form a trimming portion 20 by partially removing the element part 2 and the glass coating 4 of each chip area 12.

After the trimming has been done, the resin portion 5 is formed to cover the surface of the glass coating 4 (refer to FIG. 3E). The resin portion 5 may be formed by, for example, screen-printing (applying) a coating agent (to be described later) onto the chip area 12 and then curing the coating agent by heating, for instance. In addition, an indicator is also formed on the surface of the resin portion 5. In FIG. 3E, letters “102” are inscribed as the indicator. The indicator indicates, for example, the resistance value, product number, or model of the electronic component 10. The indicator may be formed by, for example, printing ink (e.g., by stamping) onto the surface of the resin portion 5 and then curing the ink with heat or an ultraviolet ray, for instance.

After the resin portion 5 and the indicator have been formed, the intermediate electrodes 9 are formed on the surfaces of the extraction electrodes 3. The intermediate electrodes 9 may be formed from, for example, a conductive paste including an uncured resin component and conductive particles. The intermediate electrodes 9 may be formed by, for example, screen-printing (applying) the conductive paste onto the surfaces of the portions, which are covered with neither the glass coating 4 nor the resin portion 5 (which are not covered with the insulating protective layer 13), of the extraction electrodes 3 and then curing the uncured resin component.

After the intermediate electrodes 9 have been formed, the sheet-shaped substrate 111 is divided into elongated strips (which constitutes primary division), thereby forming a strip of substrates 11 as shown in FIG. 2B. The cutting lines of the sheet-shaped substrate 111 are indicated by long dashed short dashed lines in FIG. 2A. The sheet-shaped substrate 111 is divided at both longitudinal ends of each chip area 12. Thus, a plurality of chip areas 12 are arranged side by side along the longitudinal axis of the strip of substrates 11. In addition, the extraction electrodes 3 formed in the respective chip areas 12 are also arranged side by side along the longitudinal axis of the strip of substrates 11.

Next, the electrode layers 6 are formed in each chip area 12 (refer to FIG. 3F). The electrode layers 6 are formed at both longitudinal ends of the strip of substrates 11. The electrode layers 6 may be formed by, for example, screen-printing (applying) a conductive paste and then curing the conductive paste. Alternatively, the electrode layers 6 may also be formed by sputtering, for example.

After the electrode layers 6 have been formed, the strip of substrates 11 is divided into multiple chips diced for the respective chip areas 12 (which constitutes secondary division), thereby forming substrates 1 as shown in FIG. 2C. Thereafter, the first plating layer 71 and the second plating layer 72 are sequentially formed to form the metal plating layer 7 (refer to FIG. 3G and FIG. 3H). In this manner, the electronic component 10 is completed. The electronic component 10 will be shipped after being subjected to a completion inspection and taping.

### (3) Variations

The embodiment is merely an example of various embodiments of the present disclosure. The embodiment may be modified variously depending on design and the like as long as the object of the present disclosure is achieved.

In the above description, the electronic component 10 is a chip resistor as an example, but this should not be construed as limiting.

### (Recapitulation)

As can be seen from the foregoing description, an electronic component (10) of a first aspect includes: a substrate (1); an element part (2) on the substrate (1); extraction electrodes (3) connected to the element part (2); an insulating protective layer (13); intermediate electrodes (9); and external electrodes (14) each covering a corresponding one of the intermediate electrodes (9). The insulating protective layer (13) covers the element part (2) and part of each of the extraction electrodes (3). Each of the intermediate electrodes (9) covers part of the insulating protective layer (13) and a surface of a portion of a corresponding one of the extraction electrodes (3), the portion not being covered with the insulating protective layer (13). Each of the intermediate electrodes (9) includes conductive particles and a resin component. The conductive particles include fiber-like conductive particles and flake-like conductive particles.

The first aspect has the advantage that the intermediate electrodes (9) enable the extraction electrodes (3) to be suppressed from being disconnected due to a sulfidizing gas, and in addition, a sulfide to be suppressed from being produced.

In an electronic component (10) of a second aspect referring to the first aspect, a content percentage of carbon particles in each of the intermediate electrodes (9) is less than 1 wt %.

The second aspect has the advantage that the sulfide is further suppressed from being produced.

In an electronic component (10) of a third aspect referring to the first or second aspect, a ratio by weight between the fiber-like conductive particles and the flake-like conductive particles in each of the intermediate electrodes (9) is from 5/5 to 7/3.

This aspect has the advantage that the sulfide is further suppressed from being produced.

In an electronic component (10) of a fourth aspect referring to any one of the first to third aspects, a weight of the conductive particles in a solid content of each of the intermediate electrodes (9) is greater than or equal to 46 wt % and less than or equal to 61 wt %.

The fourth aspect has the advantage that the sulfide is further suppressed from being produced.

In an electronic component (10) of a fifth aspect referring to any one of the first to fourth aspects, the resin component contains a polyfunctional epoxy resin and an epoxy curing agent.

The fifth aspect has the advantage that intermediate electrodes (9) having heat resistance can be formed.

In an electronic component (10) of a sixth aspect referring to any one of the first to fifth aspects, the fiber-like conductive particles include particles of a fiber-like inorganic substance which are covered with metal.

The sixth aspect has the advantage that the fiber-like conductive particles can be obtained while the usage amount of metal is reduced.

In an electronic component (10) of a seventh aspect referring to any one of the first to sixth aspects, the fiber-like conductive particles have a mean fiber size of greater than or equal to 0.1 μm and less than or equal to 2 μm, a mean fiber length of greater than or equal to 5 μm and less than or equal to 30 μm, and an aspect ratio of greater than or equal to 5 and less than or equal to 200.

The seventh aspect has the advantage that the sulfide is further suppressed from being produced.

In an electronic component (10) of an eighth aspect referring to any one of the first to seventh aspects, the flake-like conductive particles include thin flake-like metal powder.

The eighth aspect has the advantage that the sulfide is further suppressed from being produced.

In an electronic component (10) of a ninth aspect referring to any one of the first to eighth aspects, the flake-like conductive particles have a mean particle size of greater than or equal to 1 μm and less than or equal to 30 μm, and an aspect ratio between a thickness of each of the flake-shaped conductive particles and the mean particle size is greater than or equal to 5 and less than or equal to 300.

The ninth aspect has the advantage that the sulfide is further suppressed from being produced.

In an electronic component (10) of a tenth aspect referring to any one of the first to ninth aspects, each of the intermediate electrodes (9) includes substantially no carbon particle.

The tenth aspect has the advantage that the sulfide is further suppressed from being produced.

In an electronic component (10) of an eleventh aspect referring to any one of the first to tenth aspects, the insulating protective layer (13) includes a glass coating (4) covering the element part (2) and a resin portion (5) covering the glass coating (4).

The eleventh aspect has the advantage of reducing the chances of causing peeling between the insulating protective layer (13) and the element part (2).

In an electronic component (10) of a twelfth aspect referring to any one of the first to eleventh aspects, each of the external electrodes (14) includes an electrode layer (6) and a metal plating layer (7) covering the electrode layer (6). The electrode layer (6) is a conductor including a resin component, carbon particles, and silver powder, or a conductor formed by metal sputtering.

The twelfth aspect has the advantage that the external electrodes (14) are easily formed.

In an electronic component (10) of a thirteenth aspect referring to any one of the first to twelfth aspects, each of the external electrodes (14) covers part of the insulating protective layer (13).

The thirteenth aspect has the advantage that moisture resistance is improved.

In an electronic component (10) of a fourteenth aspect referring to any one of the first to thirteenth aspects, the extraction electrodes (3) include silver.

The fourteenth aspect has the advantage that the silver sulfide is suppressed from being produced.

In an electronic component (10) of a fifteenth aspect referring to any one of the first to fourteenth aspects, the conductive particles include silver.

The fifteenth aspect has the advantage that the silver sulfide is suppressed from being produced.

### EXAMPLES

### Examples 1 to 7, Comparative Example

The electronic component (chip resistor) shown in FIG. 1 was fabricated by performing the process steps shown in FIGS. 2A to 2C and FIGS. 3A to 3H. The intermediate electrodes were formed to have compositions shown in Table 1. As resin 1 of the polyfunctional epoxy resin, a DPP novolac epoxy resin expressed by the structural formula (1) was used. As resin 2 of the polyfunctional epoxy resin, a tetraphenylolethane epoxy resin expressed by the structural formula (2) was used. As curing agent A, an imidazole-based curing agent expressed by the structural formula (7) was used. As curing agent B, a dicyandiamide curing agent expressed by the structural formula (8) and an aromatic dimethyl urea (harden catalyst) were used together. As the fiber-like conductive particles, particles of a fiber-like inorganic substance of potassium titanate which have surfaces covered with a conductive film of silver was used. As the flake-like conductive particles, flake-like silver powder was used.

For the intermediate electrodes, a sulfidizing gas resistance test was performed, where the resistance value was measured before and after the sulfidizing gas resistance test. In the sulfidizing gas resistance test, the intermediate electrodes were left for 1000 hours in an atmosphere in which the concentration of the sulfidizing gas (H₂S) was 3 ppm, and whether silver sulfide was produced or not was observed. Then, the intermediate electrodes for which no silver sulfide was produced were labeled by “A”, the intermediate electrodes for which little silver sulfide was produced were labeled by “B”, and the intermediate electrodes for which much silver sulfide was produced were labeled by “C”. The intermediate electrodes having a resistance value of less than or equal to 6Ω were labeled by “A”, the intermediate electrodes having a resistance value of greater than 6Ω and less than or equal to 8.5Ω were labeled by “B”, and the intermediate electrodes having a resistance value of greater than 8.5Ω were labeled by “C”. The results are shown in Table 1.

TABLE 1

| | | Ex. 1 | | Ex. 2 | Ex. 3 | Ex. 4 | | Ex. 5 | | Ex. 6 | Ex. 7 | Comp. Ex. |
|---|---|---|---|---|---|---|---|---|---|---|---|---|
| Polyfunctional | Resin 1 | 100 | g | — | — | 100 | g | 100 | g | — | — | — |

| | | | | | | | | | | | | | | |
|---|---|---|---|---|---|---|---|---|---|---|---|---|---|---|
| Epoxy Resin | Resin 2 | — | 100 | g | 100 | g | — | — | 100 | g | 100 | g | 100 | g |
| Curing Agent | Curing Agent A | — | 7 | g | 7 | g | — | — | 7 | g | 7 | g | 7 | g |

| | Curing Agent B | 7 | g | — | | — | | 7 | g | 7 | g | — | | — | | — |
|---|---|---|---|---|---|---|---|---|---|---|---|---|---|---|---|---|
| Conductive | Fiber-Like | 70 | g | 50 | g | 75 | g | 105 | g | 46.6 | g | 50 | g | 117 | g | — |
| Particle | Conductive | | | | | | | | | | | | | | | |
| | Particle | | | | | | | | | | | | | | | |
| | Flake-Like | 30 | g | 50 | g | 75 | g | 45 | g | 20.0 | g | 50 | g | 117 | g | — |

Conductive
Particle

| Spherical Shape | — | | — | | — | | — | | — | | — | | — | | 275 | g |
|---|---|---|---|---|---|---|---|---|---|---|---|---|---|---|---|---|
| Carbon Particle | — | | — | | — | | — | | — | | 2.2 | g | — | | — | |
| Content of Conductive Particle | 48.3 | wt % | 48.3 | wt % | 58.4 | wt % | 58.4 | wt % | 38.3 | wt % | 47.8 | wt % | 68.6 | wt % | 72.0 | wt % |

| Ratio by Weight of Fiber-Like | 7/3 | 5/5 | 5/5 | 7/3 | 7/3 | 5/5 | | 5/5 | — |
|---|---|---|---|---|---|---|---|---|---|
| Conductive Particle/Flake-Like | | | | | | | | | |
| Conductive Particle | | | | | | | | | |
| Content of Carbon Particle | — | — | — | — | — | 1.0 | wt % | — | — |

| | | | | | | | | |
|---|---|---|---|---|---|---|---|---|
| Sulfidizing Gas Resistance Test | A | A | A | A | A | B | B | C |
| Resistance Value of | A 5.2 Ω | A 5.8 Ω | A 2.2 Ω | A 2.6 Ω | B 8.2 Ω | A 6.0 Ω | A 1.7 Ω | C 8.7 Ω |
| Intermediate Electrode | | | | | | | | |

### REFERENCE SIGNS LIST

1 Substrate
2 Element Part
3 Extraction electrode
4 Glass Coating
5 Resin Portion
6 Electrode Layer
7 Metal Plating Layer
9 Intermediate Electrode
10 Electronic Component
13 Insulating protective layer
14 External Electrode

1. An electronic component comprising:
a substrate;
an element part on the substrate;
extraction electrodes connected to the element part;
an insulating protective layer covering the element part and part of each of the extraction electrodes;
intermediate electrodes each covering part of the insulating protective layer and a surface of a portion of a corresponding one of the extraction electrodes, the portion not being covered with the insulating protective layer; and
external electrodes each covering a corresponding one of the intermediate electrodes,
each of the intermediate electrodes including conductive particles and a resin component,
the conductive particles including fiber-like conductive particles and flake-like conductive particles.

2. The electronic component of claim 1, wherein
a content percentage of carbon particles in each of the intermediate electrodes is less than 1 wt %.

3. The electronic component of claim 1, wherein
a ratio by weight between the fiber-like conductive particles and the flake-like conductive particles in the each of the intermediate electrodes is from 5/5 to 7/3.

4. The electronic component of claim 1, wherein
a weight of the conductive particles in a solid content of each of the intermediate electrodes is greater than or equal to 46 wt % and less than or equal to 61 wt %.

5. The electronic component of claim 1, wherein
the resin component contains a polyfunctional epoxy resin and an epoxy curing agent.

6. The electronic component of claim 1, wherein
the fiber-like conductive particles include particles of a fiber-like inorganic substance which are covered with metal.

7. The electronic component of claim 1, wherein
the fiber-like conductive particles have
a mean fiber size of greater than or equal to 0.1 μm and less than or equal to 2 μm,
a mean fiber length of greater than or equal to 5 μm and less than or equal to 30 μm, and
an aspect ratio of greater than or equal to 5 and less than or equal to 200.

8. The electronic component of claim 1, wherein
the flake-like conductive particles include thin flake-like metal powder.

9. The electronic component of claim 1, wherein
the flake-like conductive particles have a mean particle size of greater than or equal to 1 μm and less than or equal to 30 μm, and
an aspect ratio between a thickness of each of the flake-shaped conductive particles and the mean particle size is greater than or equal to 5 and less than or equal to 300.

10. The electronic component of claim 1, wherein
each of the intermediate electrodes includes substantially no carbon particle.

11. The electronic component of claim 1, wherein
the insulating protective layer includes
a glass coating covering the element part and
a resin portion covering the glass coating.

12. The electronic component of claim 1, wherein
each of the external electrodes includes an electrode layer and a metal plating layer covering the electrode layer, and
the electrode layer is
a conductor including a resin component, carbon particles, and silver powder or
a conductor formed by metal sputtering.

13. The electronic component of claim 1, wherein
each of the external electrodes covers part of the insulating protective layer.

14. The electronic component of claim 1, wherein
the extraction electrodes include silver.

15. The electronic component of claim 1, wherein
the conductive particles include silver.

16. The electronic component of claim 2, wherein
a ratio by weight between the fiber-like conductive particles and the flake-like conductive particles in the each of the intermediate electrodes is from 5/5 to 7/3.

17. The electronic component of claim 2, wherein
a weight of the conductive particles in a solid content of each of the intermediate electrodes is greater than or equal to 46 wt % and less than or equal to 61 wt %.

18. The electronic component of claim 2, wherein
the resin component contains a polyfunctional epoxy resin and an epoxy curing agent.
